(19) United States
(12) Patent Application Publication
(10) Pub. No.: US 2012/0171323 A1
(43) Pub. Date: Jul. 5, 2012

(54) Food Additive Containing Eugenol, Cinnamaldehyde and an Alliaceous Extract

(76) Inventors: David Bravo, Yverdon-Les-Bains (CH); Sergio Calsamiglia, San Cugat Del Valles (ES)

(21) Appl. No.: 13/383,194

(22) PCT Filed: Jul. 8, 2010
(86) PCT No.: PCT/CH2010/000177

§ 371 Date: Mar. 21, 2012

(30) Foreign Application Priority Data
Jul. 13, 2009 (CH) 1086/09
Jul. 13, 2009 (FR) 0903439

(51) Int. Cl. A23K 1/16; A23K 1/18

(52) U.S. Cl. 426/2; 426/655

(57) ABSTRACT

The invention relates to a food additive including: 30 to 45% of eugenol; 30 to 45% of cinnamaldehyde; 10 to 40% of extract of a plant belonging to the alliaceous family; the remainder up to 100% optionally comprising other compounds, in particular, organosulphur compounds. Such an additive can be added to the feed for certain animals, in particular bovines, with a view to reducing the methane production thereof. The invention also relates to a method for reducing methane emissions into the earth's atmosphere, which includes the following steps: adding a food additive according to the invention to the food ration of a ruminant; and feeding the ruminant the obtained food ration.

The invention relates to a food additive comprising eugenol, cinnamaldehyde and an extract of Alliaceae in certain proportions. Such an additive may be added to the feed of certain animals, in particular bovines, in order to reduce their methane production.

### BACKGROUND OF THE INVENTION

It is now well known that farm animals produce more greenhouse gases than vehicles.

It is considered in particular that ruminants are responsible for 18% of emissions of methane whose greenhouse effect, according to experts of Giec (Intergovernmental Group of Experts on Climate Change), is 23 times more powerful than that of carbon dioxide.

According to Argentinean scientists, a cow of about 550 kg emits, essentially through eructations, between 800 and 1000 liters of gas per day, mainly methane.

The result is that preserving the environment is a major constraint for agriculture and some American states are considering taxing more and more severely the production of methane by dairy cows.

Various attempts have already been made to reduce the production of methane by bovines.

Certain antibiotics have for example already been used in the feed. This solution is tending to be abandoned, on the one hand, because these antibiotics have, in addition to their cost, the disadvantage most of the time of being subject to administrative authorizations and, on the other hand, because it is growing more remote from the increasing desire of the consumer to consume “natural” products, or even products obtained by organic farming.

More recently, the INRA (National Institute for Agronomic Research) experimental station showed, in various trials carried out on dairy cows, that an intake of 6% lipids obtained from linseed reduces the production of methane in these animals by 27 to 37%.

Cf. “Rumen methanogenesis of dairy cows in response to increasing levels of dietary extruded linseeds”, 2nd International Symposium on Energy and Protein Metabolism and Nutrition, 9-13 Sep. 2007, Vichy, France, pp. 609-610.

Cf also. “Methane output and diet digestibility in response to feeding dairy cows with crude linseed, extruded linseed or linseed oil”, Journal of Animal Science, doi:10.2527/jas/2007-0774.

International patent application No. WO 03/094628 discloses the use of eugenol to reduce the production of methane (cf. in particular page 2, last paragraph).

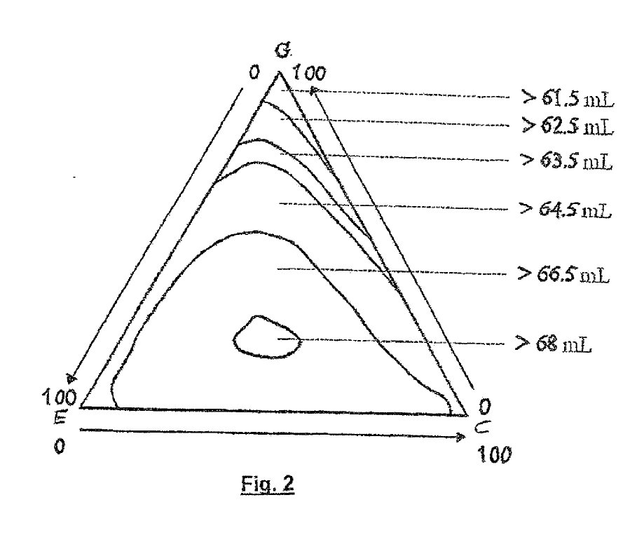

The article by Macheboeuf et al., which appeared in the review Animal Feed Science and Technology, vol. 145, Nos. 1 to 4, August 2008, pages 335 to 350 (X8002575075), reports a reduction in the production of methane due to cinnamaldehyde (see in particular FIG. 2, bottom of page 342).

International patent application No. WO 2008/0377827 teaches that the use of Alliaceae derivatives, in particular of PTS/PTSO, causes a reduction in the emission of fermentation gas, especially methanol, in ruminants (cf. page 5, 3^{rd} paragraph).

To reduce methane emissions caused by animals and partly by bovines, it would be desirable to have available a solution which is simple and inexpensive and which can be easily used. It should additionally be possible to use such a solution both in developed countries and in poor countries, some of which, like India, Brazil or Argentina, have a very large amount of livestock and therefore play a significant role in the production of greenhouse gases.

### BRIEF DISCLOSURE OF THE INVENTION

The inventors of the present invention have developed a food additive which has the characteristic feature of comprising eugenol, cinnamaldehyde and an extract of a plant belonging to the Alliaceae family, these ingredients being present in specific proportions.

The inventors have observed that the addition, to the feed ration of a ruminant, of such an additive led to a large reduction in the production of methane by this ruminant, without notably affecting the production of volatile fatty acids in the rumen, these acids being important because they serve as energy source for the animal's metabolism.

As for the production of methane, it can, in some cases, undergo a reduction of up to 25%.

Other characteristics and advantages of the invention will now be described in detail in the disclosure which follows and which is illustrated by the accompanying figures which represent:

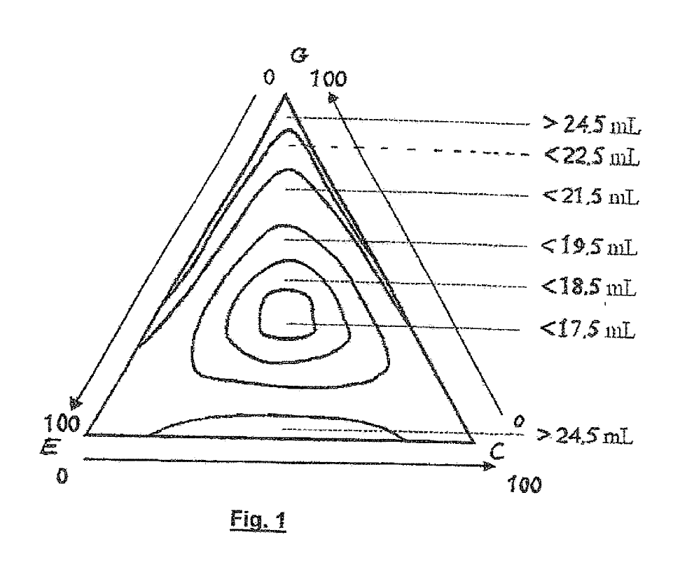

FIG. 1: a ternary graph showing the methane production curves as a function of the food additive concentrations of eugenol, cinnamaldehyde and extract of a plant belonging to the genus Allium;

FIG. 2: a ternary graph showing the volatile fatty acid production curves as a function of the food additive concentrations of eugenol, cinnamaldehyde and extract of a plant belonging to the genus Allium;

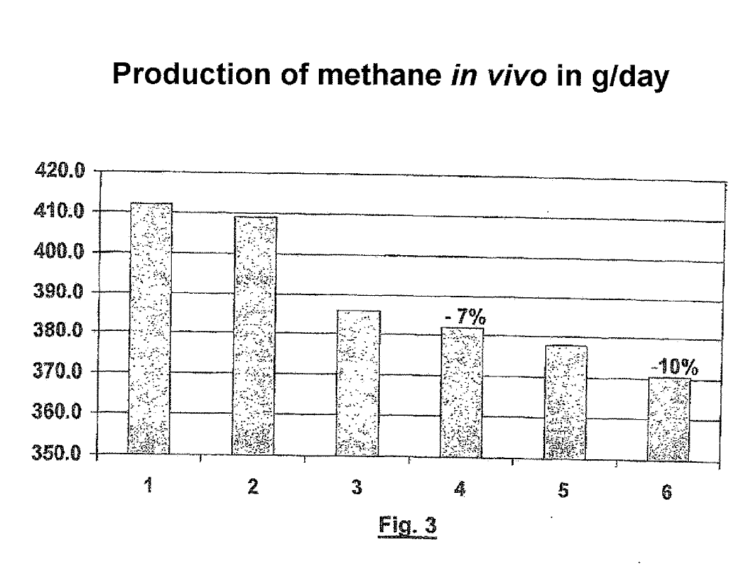

FIG. 3: a diagram showing the mean production of methane per cow and per day, in grams, for each treatment tested;

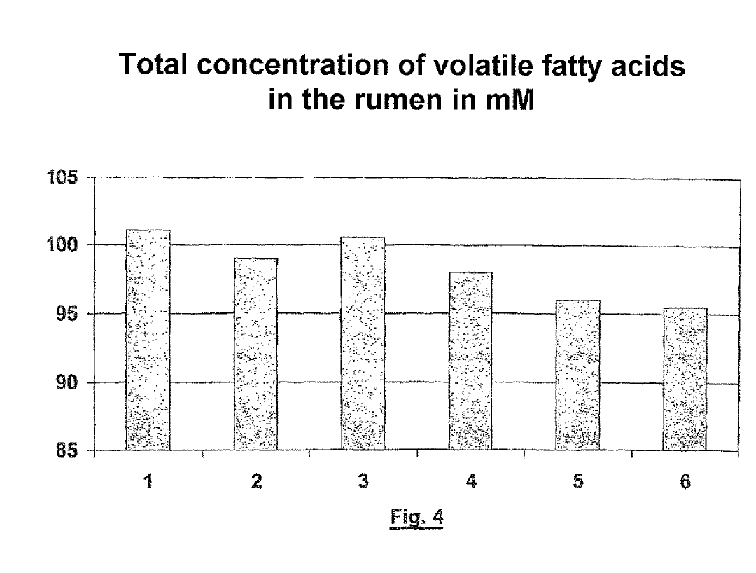

FIG. 4: a diagram presenting the ruminal fluid concentration in millimoles/l of volatile fatty acids, for each treatment tested; and

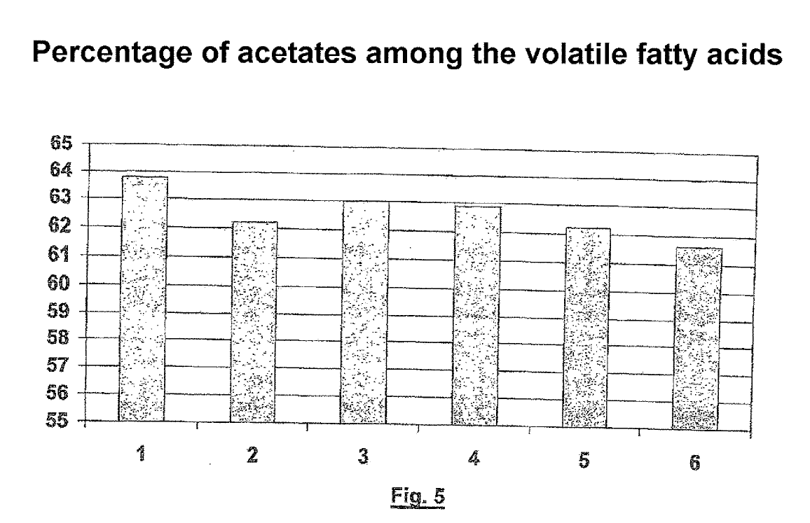

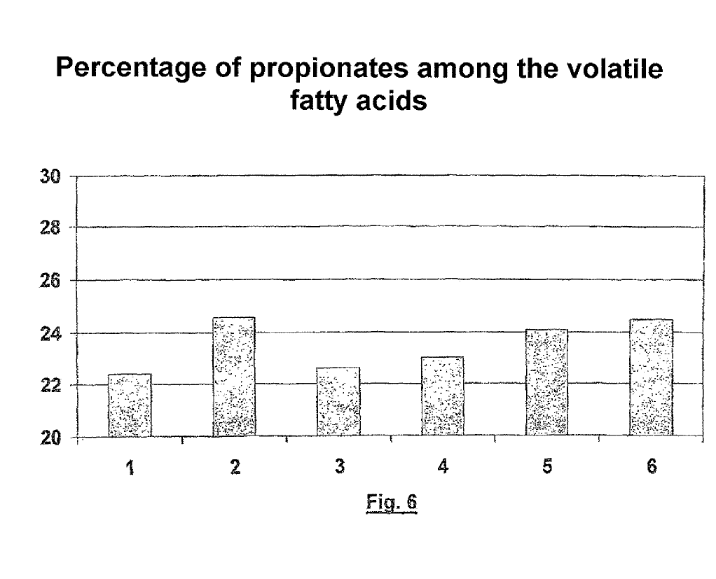

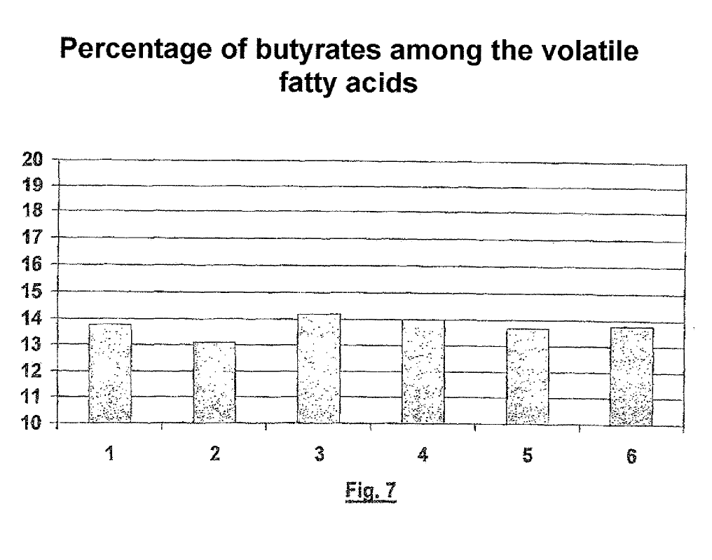

FIGS. 5 to 7: diagrams showing the percentage of acetate, propionate and butyrate among the volatile fatty acids, for each treatment tested.

### DETAILED DISCLOSURE OF THE INVENTION

The eugenol used in the food additive according to the invention is the well-known compound called 4-allyl-2-methoxyphenol, having the empirical formula C₁₀H₁₂O₂.

The cinnamaldehyde (or cinnamic aldehyde) is also well-known. It is 3-phenylpropenal (trans-cinnamaldehyde) having the empirical formula C₉H₈O.

According to the invention, the food additive comprises at least an extract of a plant belonging to the Alliaceae family (according to the APO phylogenetic classification) and in particular to the genus Allium, which is a member of this family.

The best-known plants belonging to the genus Allium are leek (Allium ampeloprasum), onion (Allium cepa L.), cultivated garlic (Allium sativum L.), shallot (Allium ascalonicum), Welsh onion (Allium fistulosum L.) and chives (Allium schoenoprasum L.).

According to the invention, an extract of cultivated garlic (Allium sativum L.) is preferably used. It is in general an extract of garlic bulb.

This garlic extract may contain a dialkyl thiosulfinate and/or at least one dialkyl thiosulfonate.

These compounds correspond to the following formula F:

R—SOₐ—S—R′
in which:
R and R′, which are identical or different, each represent an alkyl group; and
a is 1 or 2.

The alkyl groups R and R′ preferably comprise 1 to 5 carbon atoms.

Furthermore, propyl, generally n-propyl, groups are more particularly used as R and R′ groups.

Within the same compound of formula F, the R and R′ groups are preferably identical.

For a dialkyl thiosulfinate, in formula F, a is 1.

For a dialkyl thiosulfonate, a is 2.

As compound(s) of formula F, it is advantageous to use a di(n-propyl) thiosulfinate (called in the text that follows PTS) and/or a di(n-propyl)thiosulfonate (called in the text that follows PTSO).

PTSO may be obtained by decomposition (or oxidation) of PTS.

The production of PTS by extraction and of PTSO is described in particular in patent application EP-A1-1 721 534, from page 15, line 34, to page 16, line 26.

The thiosulfinates may also be obtained according to the process described in patent application FR-A-2 813 884.

However, PTS and PTSO are not necessarily obtained from Alliaceae. They may of course also be produced by synthesis.

The invention therefore also relates to a food additive comprising:
30 to 45% of eugenol,
30 to 45% of cinnamaldehyde, and
10 to 40% of at least one compound F;
the remainder up to 100% optionally comprising other compounds, in particular organosulfur compounds.

Of course, the food additive according to the invention may comprise mixtures, in any proportions, of
at least two dialkyl thiosulfinates;
at least two dialkyl thiosulfonates;
at least one dialkyl thiosulfinate and at least one dialkyl thiosulfonate.

According to an another embodiment of the invention, the compound(s) of formula F may be combined with at least one other compound, preferably a sulfur compound, in particular a sulfur compound obtained from a plant belonging to the genus Allium. This other sulfur compound may be, for example, allicin, a sulfide or a polysulfide, in particular a disulfide such as allyl disulfide.

These compounds may be in the form of a solution in a solvent such as glycerine, propylene glycol, or in the form of an aqueous emulsion using polysorbates as emulsifiers.

The food additive according to the invention may additionally contain other compounds well-known to a person skilled in the art, such as hydrogenated vegetable oils, maltodextrin D.E. 6, 9, 18.5, soybean lecithin, gelatin, cyclodextrins, pectin, guar gum, dextrose, maltose, gum arabic, sepifilm, hydroxypropylmethylcellulose, methylcellulose, ethylcellulose, ethylmethylcellulose, quillaja extracts, polyoxyethylene(20) sorbitan monolaurate, polyoxyethylene(20) sorbitan monooleate, polyoxyethylene(20) sorbitan monostearate, polyoxyethylene(20) sorbitan monopalmitate, sorbitan monolaurate, sorbitan monooleate, sorbitan monostearate, edible fatty acid mono- and diglycerides esterified with the following acids: acetic, lactic, citric, tartaric and mono-/di-acetyltartaric.

According to an advantageous embodiment of the invention, the food additive consists of:
30 to 45% of eugenol,
30 to 45% of cinnamaldehyde and
10 to 40% of garlic extract;
the sum of the percentages being 100%.

In addition, the garlic extract content is preferably between 15 and 35%, most especially between 24 and 26%.

The food additive according to the invention may be prepared by mixing, in any order, the eugenol, the cinnamaldehyde, the garlic extract and the optional other ingredients in the desired proportions, until a homogeneous mixture is obtained.

It is possible to use the usual galenic techniques such as spray cooling, coacervation, gelatinization, prilling and spraying, suspension and granulation in a fluidized air bed.

The food additive according to the invention is overall in the form of a powder consisting in general of particles having a size which may range from 90 μm (microns) to 1000 μm, in particular between 200 μm and 500 μm.

These particles may optionally be completely coated with an outer layer of coating intended to mask the taste of garlic and/or promote feed consumption by stimulating the animal's appetite. Such a coating may be the one described in the French patent application filed under the No. FR0804617.

During its use, the food additive according to the invention may be added to an animal feed concentrate. Such a feed concentrate is well-known to a person skilled in the art and may comprise soybean hulls, corn grains, oil cakes, byproducts of ethanol production from wheat or corn, and the like.

For bovine, caprine or ovine feed, the food additive according to the invention may be added to fodder such as grass, alfalfa, hay, and the like.

The food additive according to the invention can also be used to prepare an animal feed comprising an animal feed concentrate, fodder and the additive in question.

The food additive according to the invention may be measured out in a dose such that the animal ingests 100 mg to 1000 mg thereof per day. Preferably, it is measured out in a dose of 500 mg/day/animal.

The food additive according to the invention is particularly appropriate for ruminants, in particular bovines.

### EXAMPLES

### a) Tests In Vitro

Ruminal Fluid is Collected from a Cow.

A 1:1 (by volume) solution of ruminal fluid and of a buffer solution is then prepared.

50 ml of the solution are introduced into a polypropylene tube.

A ration is prepared (on a dry matter basis) consisting of alfalfa hay (34.7%), ryegrass hay (14.8%), ground barley grain (11.4%), ground corn grain (11.4%), soybean oil cake (1.6%), cotton seed (7.9%), corn gluten (11.6%), molasses (3.2%), calcium salts of fatty acids (1.3%), and a mineral and vitamin premixture (2.1%).

A feed concentrate is prepared which consists of corn, soybean oil cake, wheat and optionally other raw materials which usually enter into the composition of feed concentrates.

300 mg of ration, 200 mg of feed concentrate (which is equivalent to a 60/40 mixture of ration and concentrated feed) and 6.25 mg of food additive are introduced into the polypropylene tube, that is 250 mg of additive per 1 l of 1/1 mixture of ruminal fluid/buffer solution.

Several food additives according to the invention A1 to A4 and others serving as elements for comparison ET1 to ET6 are tested. Their compositions and quantities, expressed relative to 1 liter of ruminal fluid/buffer solution mixture, are given in the following table:

| | Eugenol | Cinnamaldehyde | Garlic extract |
|---|---|---|---|
| Additive | (mg) | (mg) | (mg) |
| ET1 | 125 | 125 | 0 |
| ET2 | 0 | 250 | 0 |
| ET3 | 250 | 0 | 0 |
| ET4 | 0 | 0 | 250 |
| ET5 | 0 | 125 | 125 |
| ET6 | 125 | 0 | 125 |
| A1 | 41.7 | 41.7 | 166.7 |
| A2 | 41.7 | 166.7 | 41.7 |
| A3 | 166.7 | 41.7 | 41.7 |
| A4 | 83.3 | 83.3 | 83.3 |

The garlic extract used here is the liquid called “GARLICON 40% Liquid Feed Grade” marketed by the Spanish company Prebia Feed Extracts S.L. of Talayera de la Reina, Toledo, which contains 400 ppm of organosulfur compounds characteristic of garlic/onion and 6.7% by weight of PTS and 34.3% by weight of PTSO.

Two controls are also tested. The first T1 is a ration containing only fodder.

The second T2 is an aqueous solution of a feed giving the solution a concentration of 500 mg of monensin (active compound produced from the mycelium of Streptomyces cinnamonensis) per liter of ruminal fluid/buffer solution mixture.

The sealed tube is kept at 39° C. for 24 h for the incubation to take place.

Gaseous samples are collected above the liquid.

The concentrations of volatile fatty acids (VFA: acetate, propionate, butyrate, valerate) and of methane are determined.

Each trial is carried out twice and repeated over 2 consecutive periods.

The results of the gas measurements are given in the following table.

The ratio called C2/C3 is the ratio between acetate (C2) and propionate (C3).

| | | Total | | | | |
|---|---|---|---|---|---|---|
| Food | Methane | VFA | % | % | % | |
| additive | ml | ml (*) | Propionate | Acetate | Butyrate | C2/C3 |
| ET1 | 24.9206 | 66.33 | 54.59 | 76.84 | 6.6 | 5.58 |
| ET2 | 19.4051 | 66.51 | 54.68 | 76.94 | 6.53 | 5.6 |
| ET3 | 18.3533 | 64.94 | 50.26 | 76.55 | 6.64 | 5.55 |
| ET4 | 23.2851 | 61.9 | 50.78 | 75.59 | 7.01 | 5.21 |
| ET5 | 23.1945 | 63.44 | 51.02 | 75.97 | 6.99 | 5.37 |
| ET6 | 23.3753 | 64.65 | 51.95 | 76.21 | 6.79 | 5.41 |
| A1 | 18.4931 | 63.36 | 49.47 | 75.83 | 6.97 | 5.33 |
| A2 | 18.4578 | 67.16 | 51.98 | 76.44 | 6.8 | 5.5 |
| A3 | 21.1599 | 69.47 | 50.65 | 76.28 | 6.75 | 5.47 |
| A4 | 17.9579 | 67.15 | 50.29 | 76.02 | 6.93 | 5.41 |

(*): in addition to propionate, acetate and butyrate, other compounds, such as valerate, isovalerate or isobutyrate, make up the remainder up to 100%.

Statistical analyses of the results carried out with the SAS software make it possible to define the following regression equation linking the concentration of methane Y (in ml) to the concentrations of the 3 constituents of the food additive:

Y=0.078E+0.0077C+0.096G+0.000356×E×C−0.000012×E×C×G

with:
E=concentration of eugenol (in %)
C=concentration of cinnamaldehyde (in %)
G=concentration of garlic extract (in %)

The production of methane can be visualized in FIG. 1.

FIG. 2 makes it possible to visualize the production of volatile fatty acids as a function of the concentrations of the 3 constituents E, C and G of the food additive.

It is observed that the production of volatile fatty acids is lower when the content of Alliaceae extract G increases in the food additive.

More detailed measurements show in addition that
the molar proportion of acetate decreases under the effect of the combination of C and G and of the combination of E, C and G;
the molar proportion of butyrate increases under the effect of the combination of C and G and of the combination of E, C and G;
the molar proportion of valerate decreases under the effect of the combination of C and G and increases under the effect of the combination of C and G and of the combination of E, C and G; and
the molar proportion of propionate increases under the effect of C, E and G alone, and decreases with the combination of C and G.

It is observed that the optimal zone, that is to say leading to the maximum reduction in the production of methane and to the best maintenance of the production of volatile fatty acids, corresponds to the following proportions of the constituents E, C and G in the food additive:
30 to 45% of eugenol,
45 to 30% of cinnamaldehyde,
about 25% of garlic extract.

Indeed, a food additive according to the invention having this composition leads to a reduction in the production of methane in the ruminant of 15 to 25% compared with a similar food additive free of garlic extract.

Thus, the preceding results clearly demonstrate that the constituents eugenol, cinnamaldehyde and the Alliaceae extract act synergistically and notably reduce the production of methane, in particular in a ruminant such as a cow.

Consequently, in order to reduce methane emissions into the earth's atmosphere and therefore contribute toward limiting global warming, it is possible to proceed as follows:
a food additive according to the invention is prepared;
this food additive is added to the feed rations for ruminants; and
the feed rations obtained are fed to the ruminants.

### b) Test In Vivo

Tests were carried out in vivo in order to confirm the results previously obtained in vivo.

### i) Animals Tested

They were Holstein cows.

### ii) Diet

Their daily ration had the following composition given in the following table:

| Ingredients | % by mass |
|---|---|
| Corn fodder | 25 |
| Alfalfa hay | 29 |
| Chopped alfalfa hay | 11 |
| Concentrated granules | 35 |
| TOTAL | 100 |

The following food additives were added to the daily ration for the cows:

| Trial | Additive added | Quantity added |
|---|---|---|
| 1 | None | — |
| 2 | T2 (see example in vitro) | 300 mg/day |
| 3 | ET7 mixture according to the | 150 mg/day |
| | invention | |
| 4 | ET7 mixture according to the | 300 mg/day |
| | invention | |
| 5 | ET7 mixture according to the | 450 mg/day |
| | invention | |
| 6 | A8: 50% by weight of ET7 | 600 mg/day |
| | mixture according to the | |
| | invention + 50% by weight of T2 | |

The ET7 mixture according to the invention consists, as percentages by mass, of 33% by weight of eugenol, of 43% of cinnamaldehyde and of 24% of garlic extract called “GARLICON 40% Liquid Feed Grade” (see example in vitro).

iii) Equipment And Experimental Method

Each cow was fitted with a small tubing attached to the muffle, between the nostrils.

Gas continuously collected by means of the tubings was analyzed over 6 periods of 25 days each.

In parallel, ruminal fluid samples were regularly collected in order to measure the total concentration of volatile fatty acids and the percentage of acetate, propionate and butyrate present among these volatile fatty acids.

### iv) Results

### 1) Production of Methane

FIG. 3 is a diagram showing the mean production of methane per cow and per day, in grams.

It is observed that the higher the content of mixture according to the invention in the daily ration, the greater the reduction in the production of methane.

A synergistic effect appears to occur for trial 6, that is to say when the mixture ET7 according to the invention is combined with the solution of monoensin.

### 2) Total Content of Volatile Fatty Acids

FIG. 4 is a diagram presenting the volatile fatty acid concentration in millimoles/l of the ruminal fluid.

It is observed that the value obtained for trial 3 is close to that for trial 1, which means that, despite the large reduction in methane production (cf. FIG. 3) obtained, the volatile fatty acid content is comparable to that of trial 1 (control).

In trial 4, the content of volatile fatty acids is only slightly lower than that of trial 1.

### 3) Percentages of Acetate, Propionate and Butyrate

The percentages of acetate, propionate and butyrate are given in FIGS. 5, 6 and 7 respectively, depending on the trials.

The lack of determination in the parameters of ruminal fermentation, or even an improvement in the latter: a reduction or a constancy in the content of acetate and a constancy or increase in the content of propionate and butyrate are observed.

### v) Conclusion

The experiments carried out in vivo confirm that the ingestion of the additive according to the invention causes a reduction in the production of methane while having virtually no effect on the production of volatile fatty acids.

1-19. (canceled)

20. A food additive comprising:
30 to 45% of eugenol,
30 to 45% of cinnamaldehyde,
10 to 40% of extract of a plant chosen from leek (Allium ampeloprasum), onion (Allium cepa L.), cultivated garlic (Allium sativum L.), shallot (Allium ascalonicum), Welsh onion (Allium fistulosum L.) and chives (Allium schoenoprasum L.),
the remainder up to 100% optionally comprising other compounds, in particular organosulfur compounds.

21. The food additive as claimed in claim 21, in which the plant is cultivated garlic (Allium sativum L.).

22. The food additive as claimed in claim 21, comprising 15 to 35% of garlic extract.

23. The food additive as claimed in claim 22, comprising 24 to 26% of garlic extract.

24. The food additive as claimed claim 21, in which the plant extract comprises at least one compound corresponding to the following formula F:
R—SOₐ—S—R′
in which:
R and R′, which are identical or different, each represent an alkyl group; and
a is 1 or 2.

25. A food additive comprising:
30 to 45% of eugenol,
30 to 45% of cinnamaldehyde, and
10 to 40% of at least one compound corresponding to the following formula F:
R—SOₐ—S—R′
in which:
R and R′, which are identical or different, each represent an alkyl group and a is 1 or 2;
the remainder up to 100% optionally comprising other compounds, in particular organosulfur compounds.

26. The food additive as claimed in claim 25, in which, in formula F, the groups R and R′ are alkyl groups comprising from 1 to 5 carbon atoms.

27. The food additive as claimed in claim 26, in which, in formula F, the R and R′ groups are propyl groups.

28. The food additive as claimed in claim 25, in which the R and R′ groups are identical.

29. The food additive as claimed in claim 25, in which, in formula F, a is 1.

30. The food additive as claimed in claim 25, in which the compound of formula F is dipropyl thiosulfinate.

31. The food additive as claimed in claim 25, in which, in formula F, a is 2.

32. The food additive as claimed in claim 25, in which the compound of formula F is dipropyl thiosulfonate.

33. The food additive as claimed in claim 25, comprising a mixture of dipropyl thiosulfinate and dipropyl thiosulfonate.

34. The use of the food additive as claimed in claim 21, for reducing the production of methane in a ruminant.

35. The use according to claim 34, wherein the use is in combination with monoensin.

36. The use as claimed in claim 35, the ruminant being a cow.

37. A process for reducing methane emissions into the earth's atmosphere, comprising the following steps:
a food additive as claimed in claim 1 is added to the feed ration for a ruminant; and
the feed ration obtained is fed to the ruminant.
